(19) United States
(12) Patent Application Publication
(10) Pub. No.: US 2022/0141698 A1
(43) Pub. Date: May 5, 2022

(54) METHOD AND DEVICE USED FOR RELAY WIRELESS COMMUNICATION

(71) Applicant: Xiaobo ZHANG, SHANGHAI (CN)

(72) Inventor: Xiaobo ZHANG, SHANGHAI (CN)

(73) Assignee: SHANGHAI LANGBO COMMUNICATION TECHNOLOGY COMPANY LIMITED, SHANGHAI (CN)

(21) Appl. No.: 17/515,561

(22) Filed: Nov. 1, 2021

(30) Foreign Application Priority Data
Nov. 5, 2020 (CN) 202011222991X

(51) Int. Cl. H04W 28/02

(52) U.S. Cl. CPC H04W 28/0205

(57) ABSTRACT

A method and device for relay wireless communications. A first node receives a first data unit set through a second logical channel; transmits a second data unit set through a first logical channel; determines a first link failure; as a response to the behavior of determining the first link failure, generates a first control message; and transmits the first control message; herein, the first control message is used to indicate that a third data unit set is not successfully transmitted; any data unit in the third data unit set belongs to the first data unit set; any bit in the second data unit set belongs to the first data unit set. In the relay transmission of the present disclosure, when a link fails, a relay node transmits a status report of packets not successfully transmitted to a source node, so as to reduce packet loss and shorten transmission delay.

### CROSS REFERENCE TO RELATED APPLICATIONS

This application claims the priority benefit of Chinese Patent Application No. 202011222991.X, filed on Nov. 5, 2020, the full disclosure of which is incorporated herein by reference.

### BACKGROUND

### Technical Field

The present disclosure relates to methods and devices in wireless communication systems, and in particular to a method and device for reporting transmission status due to a radio link failure in relay wireless communications.

### Related Art

As a multi-hop transmission technology, relay can increase throughput and expand coverage. Relay communication is a common method in cellular network communications. Data from a source node is forwarded by a relay node (RN) to a remote node. The source node and the remote node are usually a base station and a User Equipment (UE), or both UEs; the relay node may be a network device or a UE. Taking Sidelink (SL) transmission in Long Term Evolution (LTE) system as an example, a transmission from a UE to an RN adopts SL radio technology, and a transmission from a RN to a base station (eNB) adopts LTE radio technology. The RN is used for data forwarding between a UE and an eNB, which can be called Internet Protocol (IP) layer forwarding or layer 3 (L3) relaying.

Application scenarios of future wireless communication systems are becoming increasingly diversified, and different application scenarios have different performance demands on systems. To meet these various performance requirements, 3rd Generation Partner Project (3GPP) Radio Access Network (RAN) #72 Plenary decided to study New Radio (NR), or what is called the Fifth Generation (5G), and later at 3GPP RAN #75 Plenary, a Work Item (WI) was approved to standardize NR. Targeting at rapidly developing Vehicle-to-Everything (V2X) traffic, 3GPP also started SL standardization formulation and research work under NR framework. At 3GPP RAN #86 plenary, it was decided to start Study Item (SI) standardization work for NR SL Relay.

### SUMMARY

Inventors found through researches that in layer 2 relay architecture, when a failure occurs in a radio link between an RN and a remote node, packets not successfully transmitted buffered at the RN cannot continue to be transmitted to the remote node through the RN, and how a source node identify these packets needs to be studied.

To solve the above problems, the present disclosure discloses a solution for an RN to feed back a status report of packets not successfully transmitted. When a failure occurs in a link between an RN and a remote node, the RN generates a status report of packets not successfully transmitted and feeds it back to a source node, which can indicate packets needed to be retransmitted by the source node to achieve beneficial effects of reducing packet loss as well as shortening transmission delay. If no conflict is incurred, embodiments in a first node in the present disclosure and the characteristics of the embodiments are also applicable to a second node, and vice versa. And the embodiments in the present disclosure and the characteristics in the embodiments can be arbitrarily combined if there is no conflict. Further, although the present disclosure is originally targeted at relay and base station scenarios, it is also applicable to relay and terminal scenarios, where similar technical effects can be achieved. Additionally, the adoption of a unified solution for various scenarios, including but not limited to V2X scenarios and communication scenarios of terminals and base stations, contributes to the reduction of hardware complexity and costs. Particularly, for interpretations of the terminology, nouns, functions and variants (if not specified) in the present disclosure, refer to definitions given in TS36 series, TS38 series and TS37 series of 3GPP specifications.

The present disclosure provides a method in a first node for wireless communications, comprising:

receiving a first data unit set through a second logical channel, the first data unit set comprising at least one data unit;

transmitting a second data unit set through a first logical channel, the second data unit set comprising at least one data unit;

determining a first link failure; as a response to the behavior of determining the first link failure, generating a first control message; and

transmitting the first control message;

herein, the first control message is used to indicate that a third data unit set is not successfully transmitted; any data unit in the third data unit set belongs to the first data unit set;

any bit in the second data unit set belongs to the first data unit set; and a data unit comprised in the first logical channel is transmitted via the first link at air interface.

In one embodiment, the present disclosure is also applicable to scenarios where the RN is located within or outside cell coverage.

In one embodiment, the present disclosure is applicable to relay transmissions from a UE to a base station, or from a UE to a UE, or from a base station to a UE.

In one embodiment, a problem to be solved in the present disclosure is: when a failure occurs in a radio link between an RN and a remote node, packets not successfully transmitted buffered at the RN cannot continue to be transmitted to the remote node through the RN, which leads to packet loss or higher-layer retransmission, thus reducing traffic quality.

In one embodiment, a solution of the present disclosure includes: when a failure occurs in a link between an RN and a remote node, the RN generates a status report of packets not successfully transmitted and feeds it back to a source node, which can indicate the source node packets needed to be retransmitted.

In one embodiment, a beneficial effect of the present disclosure includes: a status report of packets not successfully transmitted is fed back by an RN when a failure occurs in a radio link between the RN and a remote node, which can significantly reduce packet loss and shorten transmission delay at the same time.

According to one aspect of the present disclosure, comprising:

receiving a second control message;

herein, the second control message indicates that a fourth data unit set is not successfully received; the fourth data unit set belongs to the second data unit set; any data unit in the fourth data unit set comprises at least partial bits of a data unit in the third data unit set.

According to one aspect of the present disclosure, comprising:

transmitting a third control message;

herein, the third control message indicates that the first data unit set is successfully received.

According to one aspect of the present disclosure, comprising:

the third data unit set comprising a fifth data unit set;

herein, any bit in the fifth data unit set belongs to the first data unit set and at least partial bits do not belong to the second data unit set; any data unit in the fifth data unit set is mapped to the first logical channel.

According to one aspect of the present disclosure, comprising:

the first control message being transmitted through a second logical channel;

herein, the second logical channel is mapped to the first logical channel.

According to one aspect of the present disclosure, comprising:

the first control message indicating that a sixth data unit set is not successfully received;

herein, the sixth data unit set is received through the second logical channel and does not belong to the first data unit set.

According to one aspect of the present disclosure, comprising:

the first control message indicating the first link failure.

The present disclosure provides a method in a second node for wireless communications, comprising:

transmitting a first data unit set through a second logical channel, the first data unit set comprising at least one data unit; and

receiving a first control message;

herein, a second data unit set is transmitted through a first logical channel, and the second data unit set comprises at least one data unit; a first link is determined as failed; as a response to the behavior of the first link being determined as failed, the first control message is generated; the first control message is used to indicate that a third data unit set is not successfully transmitted; any data unit in the third data unit set belongs to the first data unit set; any bit in the second data unit set belongs to the first data unit set; and a data unit comprised in the first logical channel is transmitted via the first link at air interface.

According to one aspect of the present disclosure, comprising:

a second control message being received;

herein, the second control message indicates that a fourth data unit set is not successfully received; the fourth data unit set belongs to the second data unit set; any data unit in the fourth data unit set comprises at least partial bits of a data unit in the third data unit set.

According to one aspect of the present disclosure, comprising:

receiving a third control message;

herein, the third control message indicates that the first data unit set is successfully received.

According to one aspect of the present disclosure, comprising:

the third data unit set comprising a fifth data unit set;

herein, any bit in the fifth data unit set belongs to the first data unit set and at least partial bits do not belong to the second data unit set; any data unit in the fifth data unit set is mapped to the first logical channel.

According to one aspect of the present disclosure, comprising:

the first control message being transmitted through a second logical channel;

herein, the second logical channel is mapped to the first logical channel.

According to one aspect of the present disclosure, comprising:

the first control message indicating that a sixth data unit set is not successfully received;

herein, the sixth data unit set is received through the second logical channel and does not belong to the first data unit set.

According to one aspect of the present disclosure, comprising:

the first control message indicating the first link failure.

The present disclosure provides a first node for wireless communications, comprising:

a first receiver, receiving a first data unit set through a second logical channel, the first data unit set comprising at least one data unit;

a first transmitter, transmitting a second data unit set through a first logical channel, the second data unit set comprising at least one data unit;

a first processor, determining a first link failure; as a response to the behavior of determining the first link failure, generating a first control message; and

the first transmitter, transmitting the first control message;

herein, the first control message is used to indicate that a third data unit set is not successfully transmitted; any data unit in the third data unit set belongs to the first data unit set; any bit in the second data unit set belongs to the first data unit set; and a data unit comprised in the first logical channel is transmitted via the first link at air interface.

The present disclosure provides a second node for wireless communications, comprising:

a second transmitter, transmitting a first data unit set through a second logical channel, the first data unit set comprising at least one data unit; and

a second receiver, receiving a first control message;

herein, a second data unit set is transmitted through a first logical channel, and the second data unit set comprises at least one data unit; a first link is determined as failed; as a response to the behavior of the first link being determined as failed, the first control message is generated; the first control message is used to indicate that a third data unit set is not successfully transmitted; any data unit in the third data unit set belongs to the first data unit set; any bit in the second data unit set belongs to the first data unit set; and a data unit comprised in the first logical channel is transmitted via the first link at air interface.

### BRIEF DESCRIPTION OF THE DRAWINGS

Other features, objects and advantages of the present disclosure will become more apparent from the detailed description of non-restrictive embodiments taken in conjunction with the following drawings:

FIG. 1 illustrates a flowchart of transmission of a first node according to one embodiment of the present disclosure;

FIG. 2 illustrates a schematic diagram of a network architecture according to one embodiment of the present disclosure;

FIG. 3 illustrates a schematic diagram of a radio protocol architecture of a user plane and a control plane according to one embodiment of the present disclosure;

FIG. 4 illustrates a schematic diagram of hardware modules of a communication device according to one embodiment of the present disclosure;

FIG. 5 illustrates a flowchart of radio signal transmission according to one embodiment of the present disclosure;

FIG. 6 illustrates a schematic diagram of relations among a first data unit set, a second data unit set, a third data unit set, a fourth data unit set, a fifth data unit set and a sixth data unit set according to one embodiment of the present disclosure;

FIG. 7 illustrates a schematic diagram of formats of a second control message and a third control message according to one embodiment of the present disclosure;

FIG. 8 illustrates a schematic diagram of a format of a first control message according to one embodiment of the present disclosure;

FIG. 9 illustrates a schematic diagram of another format of a first control message according to one embodiment of the present disclosure;

FIG. 10 illustrates a schematic diagram of a format of an RLC data PDU according to one embodiment of the present disclosure;

FIG. 11 illustrates a schematic diagram of a radio protocol architecture of relay transmission according to one embodiment of the present disclosure;

FIG. 12 illustrates a structure block diagram of a processing device in a first node according to one embodiment of the present disclosure;

FIG. 13 illustrates a structure block diagram of a processing device in second node according to one embodiment of the present disclosure.

### DESCRIPTION OF THE EMBODIMENTS

The technical scheme of the present disclosure is described below in further details in conjunction with the drawings. It should be noted that the embodiments of the present disclosure and the characteristics of the embodiments may be arbitrarily combined if no conflict is caused.

### Embodiment 1

Embodiment 1 illustrates a flowchart of transmission of a first node according to one embodiment of the present disclosure, as shown in FIG. 1.

In Embodiment 1, a first node 100 receives a first data unit set through a second logical channel in step 101; transmits a second data unit set through a first logical channel in step 102; determines a first link failure in step 103; as a response to the behavior of determining the first link failure, generates a first control message in step 104; transmits a first radio signal in step 105, the first radio signal carrying the first control message; herein, the first data unit set comprises at least one data unit; the second data unit set comprises at least one data unit; the first control message is used to indicate that a third data unit set is not successfully transmitted; any data unit in the third data unit set belongs to the first data unit set; any bit in the second data unit set belongs to the first data unit set; and a data unit comprised in the first logical channel is transmitted via the first link at air interface.

In one embodiment, a first data unit set is received through the second logical channel.

In one embodiment, the second logical channel is identified through a second Logical Channel Identity (LCID).

In one embodiment, the second logical channel corresponds to a second Radio Link Control (RLC) channel.

In one embodiment, the second logical channel corresponds to a second RLC entity.

In one embodiment, the second logical channel corresponds to a second Ingress RLC channel.

In one embodiment, a transmitter of the first data unit set is the second node.

In one embodiment, the first data unit set comprises at least one data unit.

In one embodiment, each data unit in the first data unit set comprises an Internet Protocol (IP) Service Data Unit (SDU).

In one embodiment, each data unit in the first data unit set comprises an Address Resolution Protocol (ARP) SDU.

In one embodiment, each data unit in the first data unit set comprises a Non-IP SDU.

In one embodiment, each data unit in the first data unit set comprises a Packet Data Convergence Protocol (PDCP) SDU.

In one embodiment, each data unit in the first data unit set comprises a PDCP protocol data unit (PDU).

In one embodiment, each data unit in the first data unit set comprises an RLC SDU.

In one embodiment, a second data unit set is transmitted through the first logical channel.

In one embodiment, the first logical channel is identified through a first LCID.

In one embodiment, the first logical channel corresponds to a first RLC channel.

In one embodiment, the first logical channel corresponds to a first RLC entity.

In one embodiment, the first logical channel corresponds to a first Egress RLC channel.

In one embodiment, a receiver of the second data unit set is a node other than the second node.

In one embodiment, a data amount of a octet comprised in the second data unit set is not greater than a data amount of a octet comprised in the first data unit set.

In one embodiment, the second data unit set comprises at least one data unit.

In one embodiment, each data unit in the second data unit set comprises an IP SDU.

In one embodiment, each data unit in the second data unit set comprises an ARP SDU.

In one embodiment, each data unit in the second data unit set comprises a Non-IP SDU.

In one embodiment, each data unit in the second data unit set comprises a PDCP SDU.

In one embodiment, each data unit in the second data unit set comprises a PDCP PDU.

In one embodiment, each data unit in the second data unit set comprises an RLC SDU, or an RLC SDU segment.

In one embodiment, an RLC SDU segment comprises partial bits of an RLC SDU.

In one embodiment, a number of octets comprised in an RLC SDU segment is not less than 1 and not greater than a difference of a number of octets comprised in an RLC SDU minus 1.

In one embodiment, any bit in the second data unit set belongs to the first data unit set.

In one embodiment, each data unit comprised in the second data unit set belongs to the first data unit set.

In one embodiment, a data unit in the second data unit set comprises at least partial bits of a data unit in the first data unit set.

In one embodiment, the behavior of determining a first link failure comprises: determining the first link failure according to a channel measurement.

In one embodiment, the behavior of determining a first link failure comprises:

determining the first link failure according to an expiration of a maintained timer T400.

In one embodiment, the behavior of determining a first link failure comprises: determining the first link failure according to an expiration of a maintained timer T310.

In one embodiment, the behavior of determining a first link failure comprises: determining the first link failure according to an expiration of a maintained timer T312.

In one embodiment, the behavior of determining a first link failure comprises: determining the first link failure according to a random access procedure failure.

In one embodiment, the behavior of determining a first link failure comprises: determining the first link failure according to RLC reaching maximum retransmission times.

In one embodiment, the behavior of determining a first link failure comprises: determining the first link failure according to a Listen Before Talk (LBT) monitoring.

In one embodiment, the behavior of determining a first link failure comprises: determining a Beam Link Failure (BLF) according to a measurement performed on a reference signal resource set.

In one embodiment, the behavior of determining a first link failure comprises: determining the first link failure according to a Beam Failure Recovery Failure.

In one embodiment, the behavior of determining a first link failure comprises: determining the first link failure according to integrity check failure indicated by PDCP entities of Sidelink-Signaling Radio Bearer 2 (SL-SRB2) and SL-SRB3 in sidelink.

In one embodiment, the behavior of determining a first link failure comprises: determining the first link failure according to continuous HARQ Discontinuous Transmission (DTX) to a specific target node indicated by a Media Access Control (MAC) entity reaching a maximum value.

In one embodiment, the behavior of transmitting the second data unit set is executed before the behavior of determining the first link failure.

In one embodiment, the behavior of receiving the second control message is executed before the behavior of determining the first link failure.

In one embodiment, a data unit comprised in the first logical channel being transmitted via the first link at air interface refers to: a data unit transmitted through the first logical channel is transmitted via the first link at air interface.

In one embodiment, the air interface comprises a Uu interface.

In one embodiment, the air interface comprises a PC5 interface.

In one embodiment, as a response to the behavior of determining the first link failure, a first control message is generated.

In one embodiment, the first control message is generated by a Radio Resource Control (RRC) sublayer.

In one embodiment, the first control message comprises an RRC message.

In one embodiment, the first control message comprises a PC5-RRC message.

In one embodiment, the first control message comprises all or partial Information Elements (IEs) in an RRC message.

In one embodiment, the first control message comprises all or partial fields in an IE in an RRC message.

In one embodiment, name of the first control message comprises relay.

In one embodiment, the first control message is RRCReconfigurationRelay.

In one embodiment, the first control message comprises RRCReconfigurationSidelink.

In one embodiment, the first control message comprises SL-ConfigDedicatedNR.

In one embodiment, the first control message comprises a PC5-S message.

In one embodiment, the first control message is generated by an RLC sublayer.

In one embodiment, the first control message comprises an RLC Control PDU.

In one embodiment, the first control message is used to indicate that the third data unit set is not successfully transmitted.

In one embodiment, the third data unit set comprises a data unit not transmitted in the first data unit set.

In one embodiment, the third data unit set comprises a data unit in which partial bits are transmitted in the first data unit set.

In one embodiment, the third data unit set comprises a data unit that is transmitted but not confirmed being successfully received in the first data unit set.

In one embodiment, the second node retransmits the third data unit set after receiving the first control message.

In one embodiment, any data unit in the third data unit set belongs to the first data unit set.

In one embodiment, the third data unit set comprises at least one data unit.

In one embodiment, the first control message is transmitted via the air interface.

In one embodiment, a target receiver of the first control message and a target receiver of the second data unit set are not co-located.

In one embodiment, a destination ID comprised in a MAC PDU used for carrying the first control message is different from a destination ID comprised in a MAC PDU used for carrying any data unit in the second data unit set.

In one embodiment, the destination ID comprised in the MAC PDU comprises a link layer identifier.

In one embodiment, the link layer identifier comprises 24 bits.

In one embodiment, the link layer identifier comprises 32 bits.

In one embodiment, the destination ID comprised in the MAC PDU comprises low 16 bits of a link layer identifier.

In one embodiment, the link layer identifier is a ProSe UE ID.

In one embodiment, the link layer identifier is a ProSe Layer-2 Group ID.

In one embodiment, the link layer identifier is a ProSe Relay UE ID.

In one embodiment, the link layer identifier is a Destination-Layer-2 ID.

In one embodiment, the link layer identifier is a Source-Layer-2 ID.

In one embodiment, a transmitter of the first data unit set is the same as a target receiver of the first control message.

### Embodiment 2

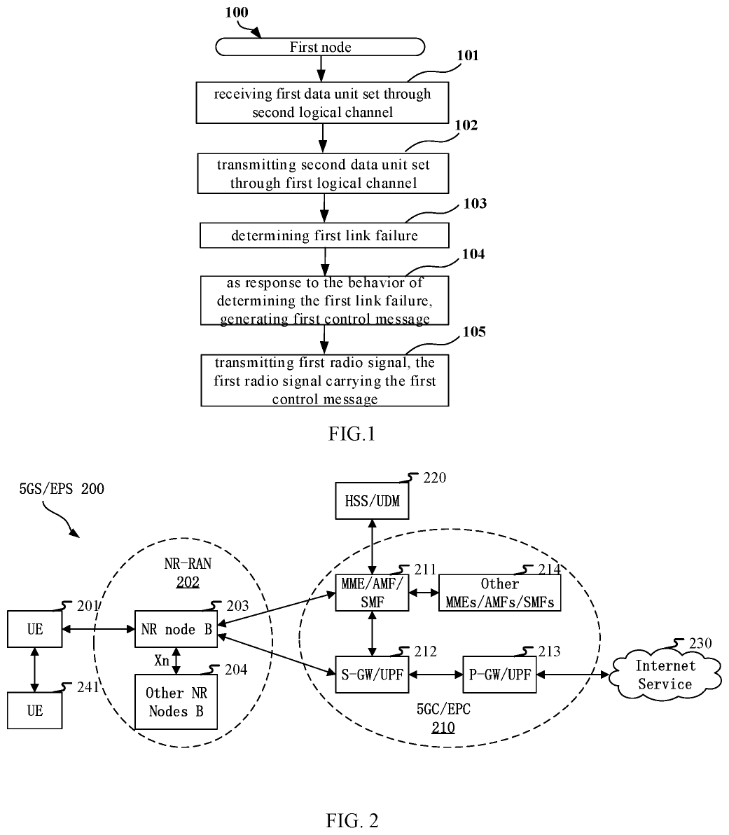

Embodiment 2 illustrates a schematic diagram of a network architecture according to one embodiment of the present disclosure, as shown in FIG. 2. FIG. 2 is a diagram illustrating a network architecture 200 of 5G NR, Long-Term Evolution (LTE), and Long-Term Evolution Advanced (LTE-A) systems. The NR 5G, LTE or LTE-A network architecture 200 may be called a 5G System (5GS)/Evolved Packet System (EPS) 200 or other appropriate terms. The 5GS/EPS 200 may comprise one or more UEs 201, an NG-RAN 202, a 5G-Core Network/Evolved Packet Core (5GC/EPC) 210, a Home Subscriber Server (HSS)/Unified Data Management (UDM) 220 and an Internet Service 230. The 5GS/EPS 200 may be interconnected with other access networks. For simple description, the entities/interfaces are not shown. As shown in FIG. 2, the 5GS/EPS 200 provides packet switching services. Those skilled in the art will readily understand that various concepts presented throughout the present disclosure can be extended to networks providing circuit switching services or other cellular networks. The NG-RAN 202 comprises an NR node B (gNB) 203 and other gNBs 204. The gNB 203 provides UE 201-oriented user plane and control plane protocol terminations. The gNB 203 may be connected to other gNBs 204 via an Xn interface (for example, backhaul). XnAP protocol of the Xn interface is used to transmit control plane messages of wireless networks, and user plane protocol of the Xn interface is used to transmit user plane data. The gNB 203 may be called a base station, a base transceiver station, a radio base station, a radio transceiver, a transceiver function, a Base Service Set (BSS), an Extended Service Set (ESS), a Transmitter Receiver Point (TRP) or some other applicable terms, and in Non Terrestrial Networks (NTNs), the gNB203 can be a satellite, an aircraft or a terrestrial base station relayed through a satellite. The gNB 203 provides an access point of the 5GC/EPC 210 for the UE 201. Examples of the UE 201 include cellular phones, smart phones, Session Initiation Protocol (SIP) phones, laptop computers, Personal Digital Assistant (PDA), Satellite Radios, Global Positioning Systems (GPSs), multimedia devices, video devices, digital audio players (for example, MP3 players), cameras, game consoles, unmanned aerial vehicles (UAV), aircrafts, narrow-band physical network devices, machine-type communication devices, land vehicles, automobiles, vehicle equipment, On-board communication unit, wearable devices, or any other similar functional devices. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the 5GC/EPC 210 via an S1/NG interface. The 5GC/EPC 210 comprises a Mobility Management Entity (MME)/Authentication Management Field (AMF)/Session Management Function (SMF) 211, other MMES/AMFs/SMFs 214, a Service Gateway (S-GW)/User Plane Function (UPF) 212 and a Packet Date Network Gateway (P-GW)/UPF 213. The MME/AMF/SMF 211 is a control node for processing a signaling between the UE 201 and the 5GC/EPC 210. Generally, the MME/AMF/SMF 211 provides bearer and connection management. All user Internet Protocol (IP) packets are transmitted through the S-GW/UPF 212, the S-GW/UPF 212 is connected to the P-GW/UPF 213. The P-GW provides UE IP address allocation and other functions. The P-GW/UPF 213 is connected to the Internet Service 230. The Internet Service 230 comprises IP services corresponding to operators, specifically including Internet, Intranet, IP Multimedia Subsystem (IMS) and Packet Switching Streaming Services (PSS).

In one embodiment, the UE 201 corresponds to a first node in the present disclosure, and the NR node B 203 corresponds to a second node in the present disclosure.

In one embodiment, the UE 201 corresponds to a first node in the present disclosure, and the UE 241 corresponds to a second node in the present disclosure.

In one embodiment, the gNB 203 is a Marco Cell base station.

In one embodiment, the gNB 203 is a Micro Cell base station.

In one embodiment, the gNB 203 is a Pico Cell base station.

In one embodiment, the gNB 203 is a Femtocell.

In one embodiment, the gNB 203 is a base station supporting large delay differences.

In one embodiment, the gNB 203 is a flight platform.

In one embodiment, the gNB 203 is satellite equipment.

In one embodiment, the gNB 203 is a base station supporting large delay difference.

In one embodiment, the gNB 203 is a test device (e.g., a transceiver device simulating some functions of a base station, a signaling tester).

In one embodiment, a radio link from the UE 201 to the gNB 203 is an uplink, and the uplink is used for executing an uplink transmission.

In one embodiment, a radio link from the gNB 203 to the UE 201 is a downlink, and the downlink is used for executing a downlink transmission.

In one embodiment, a radio link between the UE 201 and the UE 241 is a sidelink, and the sidelink is used for executing a sidelink transmission.

In one embodiment, the UE 201 and the gNB203 are connected via a Uu interface.

In one embodiment, the UE 201 and the UE241 are connected via a PC5 interface.

### Embodiment 3

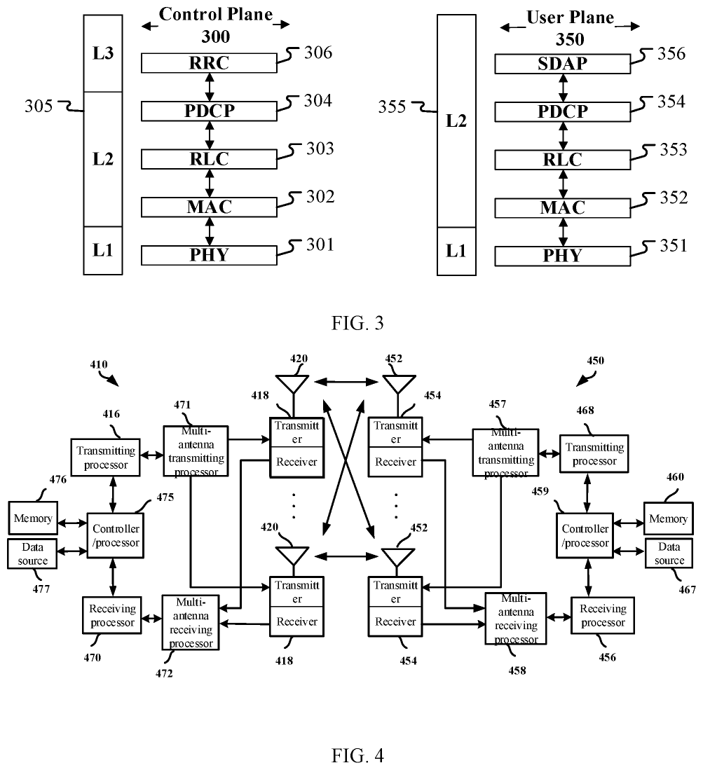

Embodiment 3 illustrates a schematic diagram of a radio protocol architecture of a user plane and a control plane according to one embodiment of the present disclosure, as shown in FIG. 3. FIG. 3 is a schematic diagram illustrating an embodiment of a radio protocol architecture of a user plane 350 and a control plane 300. In FIG. 3, the radio protocol architecture for the control plane 300 of a UE and a gNB is represented by three layers, which are a layer 1, a layer 2 and a layer 3, respectively. The layer 1 (L1) is the lowest layer and performs signal processing functions of various PHY layers. The L1 is called PHY 301 in the present disclosure. The layer 2 (L2) 305 is above the PHY 301, and is in charge of the link between the UE and the gNB via the PHY 301. L2 305 comprises a Medium Access Control (MAC) sublayer 302, a Radio Link Control (RLC) sublayer 303 and a Packet Data Convergence Protocol (PDCP) sublayer 304. All the three sublayers terminate at the gNBs of the network side. The PDCP sublayer 304 provides data encryption and integrity protection and also provides support for a UE handover between gNBs. The RLC sublayer 303 provides segmentation and reassembling of a packet, retransmission of a lost data packet through ARQ, as well as repeat data packet detection and protocol error detection. The MAC sublayer 302 provides mapping between a logic channel and a transport channel and multiplexing of the logical channel ID. The MAC sublayer 302 is also responsible for allocating between UEs various radio resources (i.e., resources block) in a cell. The MAC sublayer 302 is also responsible for Hybrid Automatic Repeat Request (HARM) operation. The Radio Resource Control (RRC) sublayer 306 in layer 3 (L3) of the control plane 300 is responsible for acquiring radio resources (i.e., radio bearer) and configuring lower layer with an RRC signaling between the gNB and the UE. Although not shown, the RRC sublayer 306 in the control plane 300 of the UE may also have a V2X layer, and the V2X layer is responsible for generating a PC5 QoS parameter group and QoS rules according to received service data or service requests, a PC5 QoS flow is generated corresponding to the PC5 QoS parameter group, and a PC5 QoS flow ID and the corresponding PC5 QoS parameter group are transmitted to an Access Stratum (AS) Layer for the AS layer to perform QoS processing of a packet belonging to the PC5 QoS flow ID; the V2X layer also comprises a PC5-Signaling Protocol sublayer, and the V2X layer is responsible for indicating whether each transmission of the AS layer is a PC5-S transmission or a V2X service data transmission. The radio protocol architecture of the user plane 350 comprises layer 1 (L1) and layer 2 (L2). In the user plane 350, the radio protocol architecture is almost the same as the corresponding layer and sublayer in the control plane 300 for physical layer 351, PDCP sublayer 354, RLC sublayer 353 and MAC sublayer 352 in L2 layer 355, but the PDCP sublayer 354 also provides a header compression for a higher-layer packet so as to reduce a radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. The radio protocol architecture of the UE in the user plane 350 may comprise part or all of protocol sublayers of the SDAP sublayer 356, the PDCP sublayer 354, the RLC sublayer 353 and the MAC subalyer 352 at L2 layer. Although not described in FIG. 3, the UE may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the RLC channel comprises a Service Access Point (SAP) between the RLC 303 and the PDCP 304.

In one embodiment, the RLC channel comprises an SAP between the RLC 353 and the PDCP 354.

In one embodiment, a logical channel comprises an SAP between the RLC 303 and the MAC 302.

In one embodiment, a logical channel comprises an SAP between the RLC 353 and the MAC 352.

In one embodiment, a transport channel comprises an SAP between the MAC 302 and the PHY 301.

In one embodiment, a transport channel comprises an SAP between the MAC 352 and the PHY 351.

In one embodiment, entities of multiple sublayers of the control plane in FIG. 3 form a Signaling Radio Bear (SRB) in the vertical direction.

In one embodiment, entities of multiple sublayers of the user plane in FIG. 3 form a Data Radio Bear (DRB) in the vertical direction.

In one embodiment, the radio protocol architecture in FIG. 3 is applicable to the first node in the present disclosure.

In one embodiment, the radio protocol architecture in FIG. 3 is applicable to the second node in the present disclosure.

In one embodiment, the first control message in the present disclosure is generated by the RLC 303.

In one embodiment, the first control message in the present disclosure is generated by the RLC 353.

In one embodiment, the first control message in the present disclosure is generated by the RRC 306.

In one embodiment, the third control message in the present disclosure is generated by the RLC 303.

In one embodiment, the third control message in the present disclosure is generated by the RLC 353.

In one embodiment, the second data unit set in the present disclosure is generated by the RLC 303.

In one embodiment, the second data unit set in the present disclosure is generated by the RLC 353.

In one embodiment, the L2 layer 305 or 355 belongs to a higher layer.

In one embodiment, the RRC sublayer 306 in the L3 layer belongs to a higher layer.

### Embodiment 4

Embodiment 4 illustrates a schematic diagram of hardware modules of a communication device according to one embodiment of the present disclosure, as shown in FIG. 4. FIG. 4 is a block diagram of a first communication device 450 in communication with a second communication device 410 in an access network.

The first communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

The second communication device 410 comprises a controller/processor 475, a memory 476, a data source 477, a receiving processor 470, a transmitting processor 416, a multi-antenna receiving processor 472, a multi-antenna transmitting processor 471, a transmitter/receiver 418 and an antenna 420.

In a transmission from the second communication device 410 to the first communication device 450, at the second communication device 410, a higher layer packet from the core network or a higher layer packet from the data source 477 is provided to the controller/processor 475. The core network and the data source 477 represents all protocol layers above the L2 layer. The controller/processor 475 provides a function of the L2 layer. In the transmission from the second communication device 410 to the first communication device 450, the controller/processor 475 provides header compression, encryption, packet segmentation and reordering, and multiplexing between a logical channel and a transport channel, and radio resources allocation for the first communication device 450 based on various priorities. The controller/processor 475 is also responsible for retransmission of a lost packet and a signaling to the first communication device 450. The transmitting processor 416 and the multi-antenna transmitting processor 471 perform various signal processing functions used for the L1 layer (that is, PHY). The transmitting processor 416 performs coding and interleaving so as to ensure an FEC (Forward Error Correction) at the second communication device 410 side, and the mapping to signal clusters corresponding to each modulation scheme (i.e., BPSK, QPSK, M-PSK, M-QAM, etc.). The multi-antenna transmitting processor 471 performs digital spatial precoding, including codebook-based precoding and non-codebook-based precoding, and beamforming on encoded and modulated symbols to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multi-carrier symbol streams. After that the multi-antenna transmitting processor 471 performs transmission analog precoding/beamforming on the time-domain multi-carrier symbol streams. Each transmitter 418 converts a baseband multicarrier symbol stream provided by the multi-antenna transmitting processor 471 into a radio frequency (RF) stream. Each radio frequency stream is later provided to different antennas 420.

In a transmission from the second communication device 410 to the first communication device 450, at the second communication device 450, each receiver 454 receives a signal via a corresponding antenna 452. Each receiver 454 recovers messages modulated to the RF carrier, converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs receiving analog precoding/beamforming on a baseband multicarrier symbol stream from the receiver 454. The receiving processor 456 converts the baseband multicarrier symbol stream after receiving the analog precoding/beamforming from time domain into frequency domain using FFT. In frequency domain, a physical layer data signal and a reference signal are de-multiplexed by the receiving processor 456, wherein the reference signal is used for channel estimation, while the data signal is subjected to multi-antenna detection in the multi-antenna receiving processor 458 to recover any the first communication device-targeted spatial stream. Symbols on each spatial stream are demodulated and recovered in the receiving processor 456 to generate a soft decision. Then the receiving processor 456 decodes and de-interleaves the soft decision to recover the higher-layer data and control signal transmitted on the physical channel by the second communication node 410. Next, the higher-layer data and control signal are provided to the controller/processor 459. The controller/processor 459 performs functions of the L2 layer. The controller/processor 459 can be connected to a memory 460 that stores program code and data. The memory 460 can be called a computer readable medium. In a transmission from the second communication device 410 to the first communication device 450, the controller/processor 459 provides multiplexing between a transport channel and a logical channel, packet reassembling, decryption, header decompression, control signal processing so as to recover a higher-layer packet from the second communication device 410. The higher-layer packet is later provided to all protocol layers above the L2 layer, or various control signals can be provided to the L3 layer for processing.

In a transmission from the first communication device 450 to the second communication device 410, at the second communication device 450, the data source 467 is configured to provide a higher-layer packet to the controller/processor 459. The data source 467 represents all protocol layers above the L2 layer. Similar to a transmitting function of the second communication device 410 described in the transmission from the second communication device 410 to the first communication device 450, the controller/processor 459 performs header compression, encryption, packet segmentation and reordering, and multiplexing between a logical channel and a transport channel so as to provide the L2 layer functions used for the user plane and the control plane. The controller/processor 459 is also responsible for retransmission of a lost packet, and a signaling to the second communication device 410. The transmitting processor 468 performs modulation mapping and channel coding. The multi-antenna transmitting processor 457 implements digital multi-antenna spatial precoding, including codebook-based precoding and non-codebook-based precoding, as well as beamforming. Following that, the generated spatial streams are modulated into multicarrier/single-carrier symbol streams by the transmitting processor 468, and then modulated symbol streams are subjected to analog precoding/beamforming in the multi-antenna transmitting processor 457 and provided from the transmitters 454 to each antenna 452. Each transmitter 454 first converts a baseband symbol stream provided by the multi-antenna transmitting processor 457 into a radio frequency symbol stream, and then provides the radio frequency symbol stream to the antenna 452.

In the transmission from the first communication device 450 to the second communication device 410, the function at the second communication device 410 is similar to the receiving function at the first communication device 450 described in the transmission from the second communication device 410 to the first communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and multi-antenna receiving processor 472 collectively provide functions of the L1 layer. The controller/processor 475 provides functions of the L2 layer. The controller/processor 475 can be connected with the memory 476 that stores program code and data. The memory 476 can be called a computer readable medium. In the transmission from the first communication device 450 to the second communication device 410, the controller/processor 475 provides de-multiplexing between a transport channel and a logical channel, packet reassembling, decryption, header decompression, control signal processing so as to recover a higher-layer packet from the first communication device 450. The higher layer packet from the controller/processor 475 can be provided to all protocol layers above the core network or the L2 layer, and various control signals can also be provided to the core network or L3 layer for L3 layer processing.

In one embodiment, the first communication device 450 comprises at least one processor and at least one memory. The at least one memory comprises computer program codes; the at least one memory and the computer program codes are configured to be used in collaboration with the at least one processor, the first communication device 450 at least receives a first data unit set through a second logical channel, the first data unit set comprises at least one data unit; transmits a second data unit set through a first logical channel, the second data unit set comprises at least one data unit; determines a first link failure; as a response to the behavior of determining the first link failure, generates a first control message; and transmits the first control message; herein, the first control message is used to indicate that a third data unit set is not successfully transmitted; any data unit in the third data unit set belongs to the first data unit set; any bit in the second data unit set belongs to the first data unit set; and a data unit comprised in the first logical channel is transmitted via the first link at air interface.

In one embodiment, the first communication device 450 comprises a memory that stores a computer readable instruction program. The computer readable instruction program generates an action when executed by at least one processor. The action includes: receiving a first data unit set through a second logical channel, the first data unit set comprising at least one data unit; transmitting a second data unit set through a first logical channel, the second data unit set comprising at least one data unit; determining a first link failure; as a response to the behavior of determining the first link failure, generating a first control message; and transmitting the first control message; herein, the first control message is used to indicate that a third data unit set is not successfully transmitted; any data unit in the third data unit set belongs to the first data unit set; any bit in the second data unit set belongs to the first data unit set; and a data unit comprised in the first logical channel is transmitted via the first link at air interface.

In one embodiment, the second communication device 410 comprises at least one processor and at least one memory. The at least one memory comprises computer program codes; the at least one memory and the computer program codes are configured to be used in collaboration with the at least one processor. The second communication device 410 at least transmits a first data unit set through a second logical channel, the first data unit set comprises at least one data unit; and receives a first control message; herein, a second data unit set is transmitted through a first logical channel, and the second data unit set comprises at least one data unit; a first link is determined as failed; as a response to the behavior of the first link being determined as failed, the first control message is generated; the first control message is used to indicate that a third data unit set is not successfully transmitted; any data unit in the third data unit set belongs to the first data unit set; any bit in the second data unit set belongs to the first data unit set; and a data unit comprised in the first logical channel is transmitted via the first link at air interface.

In one embodiment, the second communication device 410 comprises a memory that stores a computer readable instruction program. The computer readable instruction program generates an action when executed by at least one processor. The action includes: transmitting a first data unit set through a second logical channel, the first data unit set comprising at least one data unit; and receiving a first control message; herein, a second data unit set is transmitted through a first logical channel, and the second data unit set comprises at least one data unit; a first link is determined as failed; as a response to the behavior of the first link being determined as failed, the first control message is generated; the first control message is used to indicate that a third data unit set is not successfully transmitted; any data unit in the third data unit set belongs to the first data unit set; any bit in the second data unit set belongs to the first data unit set; and a data unit comprised in the first logical channel is transmitted via the first link at air interface.

In one embodiment, the first communication device 450 corresponds to a first node in the present disclosure, and the second communication device 410 corresponds to a second node in the present disclosure.

In one embodiment, the first communication device 450 is a relay node.

In one embodiment, the second communication device 450 is a UE.

In one embodiment, the second communication device 410 is a base station.

In one embodiment, the second communication device 410 is a UE.

In one embodiment, the second communication device 410 is a relay node.

In one embodiment, at least one of the antenna 420, the transmitter 418, the multi-antenna transmitting processor 471, the transmitting processor 416 or the controller/processor 475 is used to transmit a first data unit set in the present disclosure.

In one embodiment, at least one of the antenna 452, the receiver 454, the multi-antenna receiving processor 458, the receiving processor 456 or the controller/processor 459 is used to receive a first data unit set in the present disclosure.

In one embodiment, at least one of the antenna 452, the transmitter 454, the multi-antenna transmitting processor 457, the transmitting processor 468 or the controller/processor 459 is used to transmit a second data unit set in the present disclosure.

In one embodiment, at least one of the antenna 452, the transmitter 454, the multi-antenna transmitting processor 457, the transmitting processor 468 or the controller/processor 459 is used to transmit a first control message in the present disclosure.

In one embodiment, at least one of the antenna 420, the receiver 418, the multi-antenna receiving processor 472, the receiving processor 470 or the controller/processor 475 is used to receive a first control message in the present disclosure.

In one embodiment, at least one of the antenna 452, the receiver 454, the multi-antenna receiving processor 458, the receiving processor 456 or the controller/processor 459 is used to receive a second control message in the present disclosure.

In one embodiment, at least one of the antenna 452, the transmitter 454, the multi-antenna transmitting processor 457, the transmitting processor 468 or the controller/processor 459 is used to transmit a third control message in the present disclosure.

In one embodiment, at least one of the antenna 420, the receiver 418, the multi-antenna receiving processor 472, the receiving processor 470 or the controller/processor 475 is used to receive a third control message in the present disclosure.

In one embodiment, the data source 467 is used to determine a first link failure.

### Embodiment 5

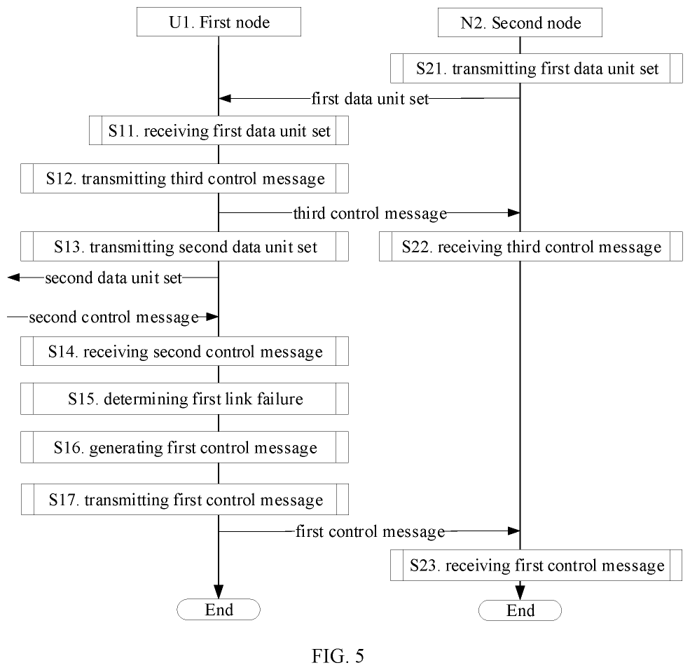

Embodiment 5 illustrates a flowchart of radio signal transmission according to one embodiment in the present disclosure, as shown in FIG. 5. In FIG. 5, a first node U1 and a second node N2 are in communications via an air interface. It is particularly underlined that the order illustrated in the embodiment does not put constraints over sequences of signal transmissions and implementations.

The first node U1 receives a first data unit set in step S11; transmits a third control message in step S12; transmits a second data unit set in step S13; receives a second control message in step S14; determines a first link failure in step S15; generates a first control message in step S16; and transmits a first control message in step S17.

The second node N2 transmits a first data unit set in step S21; receives a third control message in step S22; and receives a first control message in step S23.

In one embodiment, the third control message is generated by the second RLC entity.

In one embodiment, the third control message is transmitted, and the third control message indicates that the first data unit set is successfully received.

In one embodiment, a target receiver of the third control message is the same as a target receiver of the first control message.

In one embodiment, the third control message comprises an RLC control PDU.

In one embodiment, the third control message comprises a STATUS PDU; the STATUS PDU comprises a STATUS PDU payload and an RLC control PDU header.

In one embodiment, the third control message indicates a Sequence Number (SN) of a next not received RLC SDU after the first data unit set.

In one embodiment, the third control message is transmitted through the second logical channel.

In one embodiment, the second control message is received by the first RLC entity.

In one embodiment, a transmitter of the second control message is the same as a target receiver of the second data unit set.

In one embodiment, the second control message comprises an RLC control PDU.

In one embodiment, the second control message comprises a STATUS PDU; and the STATUS PDU comprises a STATUS PDU payload and an RLC control PDU header.

In one embodiment, the second control message indicates that the fourth data unit set is not successfully received.

In one embodiment, the second control message indicates an SN of each data unit in the fourth data unit set.

In one embodiment, the second control message indicates an SN of each data unit that is not successfully received; and the not successfully received each data unit belongs to the fourth data unit set.

In one embodiment, the fourth data unit set comprises a non-negative integer number of data unit(s).

In one embodiment, any data unit in the fourth data unit set comprises an RLC SDU, or an RLC SDU segment.

In one embodiment, the fourth data unit set belongs to the second data unit set.

In one embodiment, each data unit in the fourth data unit set is transmitted and not successfully received.

In one embodiment, any data unit in the fourth data unit set comprises at least partial bits of a data unit in the third data unit set.

In one embodiment, a data unit in the third data unit set is an RLC SDU; a data unit in the fourth data unit set is an RLC SDU, or an RLC SDU segment; a data unit in the fourth data unit set comprises an RLC SDU comprised in a data unit in the third data unit set, or, a data unit in the fourth data unit set comprises an RLC SDU segment of a data unit in the third data unit set.

In one embodiment, the third data unit set comprises the fifth data unit set.

In one embodiment, a data amount of a octet comprised in the third data unit set is not less than a data amount of a octet comprised in the fifth data unit set.

In one embodiment, the fifth data unit set comprises a non-negative integer number of data unit(s).

In one embodiment, the fifth data unit set comprises an RLC SDU.

In one embodiment, the fifth data unit set does not comprise an RLC SDU segment.

In one embodiment, any bit in the fifth data unit set belongs to the first data unit set and at least partial bits do not belong to the second data unit set.

In one embodiment, any data unit in the fifth data unit set belongs to the first data unit set and does not belong to the second data unit set.

In one embodiment, a first part of bit(s) of a data unit in the fifth data unit set belongs(belong) to the second data unit set; a second part of bit(s) of a data unit in the fifth data unit set does(do) not belong to the second data unit set; the first part of bit(s) and the second part of bit(s) respectively comprise at least one bit; and the first part of bit(s) and the second part of bit(s) consist of the data unit in the fifth data unit set.

In one embodiment, the fifth data unit set is buffered in the first RLC entity.

In one embodiment, the fifth data unit set being buffered in the first RLC entity includes: at least partial bits in the fifth data unit set are buffered in the first RLC entity.

In one embodiment, the fifth data unit set is buffered in a first SideLink Adaptation Protocol (SLAP) entity.

In one embodiment, the first SLAP entity provides a service access point to the first RLC entity.

In one embodiment, the fifth data unit set is buffered in the second RLC entity.

In one embodiment, a first part of data unit(s) in the fifth data unit set is(are) buffered in the first RLC entity; a second part in the fifth data unit set is buffered in the first SLAP entity; the first part of data unit(s) in the fifth data unit set and the second part of data unit(s) in the fifth data unit set respectively comprise at least one data unit; the first part of data unit(s) in the fifth data unit set and the second part of data unit(s) in the fifth data unit set constitute the fifth data unit set.

In one embodiment, a first part of data unit(s) in the fifth data unit set is(are) buffered in the first RLC entity; a second part in the fifth data unit set is buffered in the second RLC entity; the first part of data unit(s) in the fifth data unit set and the second part of data unit(s) in the fifth data unit set respectively comprise at least one data unit; the first part of data unit(s) in the fifth data unit set and the second part of data unit(s) in the fifth data unit set constitute the fifth data unit set.

In one embodiment, a first part of data unit(s) in the fifth data unit set is(are) buffered in the second RLC entity; a second part in the fifth data unit set is buffered in the first SLAP entity; the first part of data unit(s) in the fifth data unit set and the second part of data unit(s) in the fifth data unit set respectively comprise at least one data unit; the first part of data unit(s) in the fifth data unit set and the second part of data unit(s) in the fifth data unit set constitute the fifth data unit set.

In one embodiment, a first part of data unit(s) in the fifth data unit set is(are) buffered in the first RLC entity; a second part of data unit(s) in the fifth data unit set is(are) buffered in the first SLAP entity; a third part in the fifth data unit set is buffered in the second RLC entity; the first part of data unit(s) in the fifth data unit set, the second part of data unit(s) in the fifth data unit set and the third part of data unit(s) in the fifth data unit set respectively comprise at least one data unit; the first part of data unit(s) in the fifth data unit set, the second part of data unit(s) in the fifth data unit set and the third part of data unit(s) in the fifth data unit set constitute the fifth data unit set.

In one embodiment, any data unit in the fifth data unit set is mapped to the first logical channel.

In one embodiment, the first node maintains a mapping relation from the second logical channel to the first logical channel.

In one embodiment, a data unit received from the second logical channel is mapped to the first logical channel.

In one embodiment, a data unit received from the second logical channel is transmitted through the first logical channel.

In one embodiment, a data unit received from the second RLC entity is forwarded to the first RLC entity for processing.

In one embodiment, an RLC SDU identified by the second LCID is transmitted to an RLC entity identified by the first LCID.

In one embodiment, a first data unit is transmitted to the first RLC entity through the first RLC channel, and after the first RLC entity is processed, at least partial bits of the first data unit are used to generate an RLC data PDU to be transmitted; and the first data unit belongs to the first data unit set, and the at least partial bits in the first data unit belong to the second data unit set.

In one embodiment, the second RLC entity determines that the sixth data unit set is not successfully received.

In one embodiment, for the behavior of determining that the sixth data unit set is not successfully received, refer to 3GPP specifications 38.322 and 36.322.

In one embodiment, the first control message indicates the sixth data unit set.

In one embodiment, the sixth data unit set comprises a non-negative integer number of data unit(s).

In one embodiment, each data unit in the sixth data unit set comprises an RLC SDU.

In one embodiment, the sixth data unit set is transmitted through the second logical channel and does not belong to the first data units set.

In one embodiment, a LCID comprised in a MAC PDU carrying any data unit in the sixth data unit set is the same as a LCID comprised in a MAC PDU carrying any data unit in the first data unit set.

In one embodiment, the first control message is transmitted through the second logical channel.

In one embodiment, the first control message is generated and transmitted by the second RCL entity.

In one embodiment, the first control message is generated by the first RLC entity and is transmitted to the second RLC entity to be transmitted.

In one embodiment, a LCID comprised in a MAC PDU carrying the first control message is the same as a LCID comprised in a MAC PDU carrying the first data unit set.

In one embodiment, the first control message indicates the first link failure.

In one embodiment, the first control message comprises an IE, and the IE indicating the first link failure.

In one subembodiment of the above embodiment, name of the IE comprises relay.

In one subembodiment of the above embodiment, the IE carries a cause of the first link failure.

### Embodiment 6

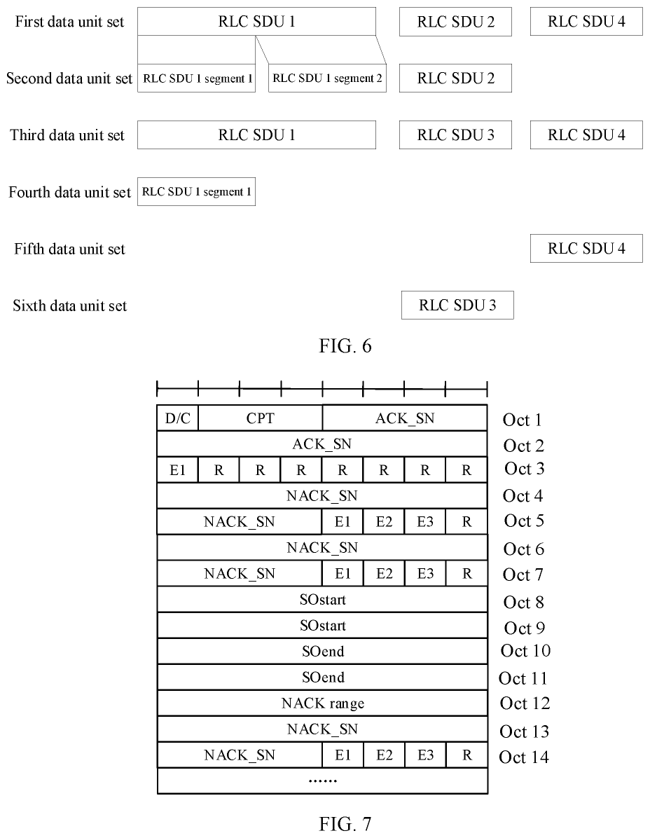

Embodiment 6 illustrates a schematic diagram of relations among a first data unit set, a second data unit set, a third data unit set, a fourth data unit set, a fifth data unit set and a sixth data unit set according to one embodiment of the present disclosure, as shown in FIG. 6.

In FIG. 6, the first data unit set comprising three RLC SDUs is illustrated as an example, wherein the three RLC SDUs comprised in the first data unit set are RLC SDU 1, RLC SDU 2 and RLC SDU 4 respectively, and the corresponding RLC SNs are 1, 2 and 4 respectively; the second data unit set comprises three data units of RLC SDU 1 segment 1, RLC SDU 1 segment 2 and RLC SDU 2 respectively, wherein the RLC SDU 1 segment 1 and RLC SDU 1 segment 2 constitute the RLC SDU 1; the second control message indicates that the RLC SDU 1 segment 1 is not successfully received, so the fourth data unit set comprises the RLC SDU 1 segment 1; the

RLC SDU 1 segment 1 belongs to the RLC SDU 1, so the third data unit set comprises the RLC SDU 1; the fifth data unit set comprises a data unit RLC SDU 4 not transmitted in the first data unit set; the sixth data unit set comprises a data unit RLC SDU 3 not successfully received; therefore, the third data unit set comprises three data units of the RLC SDU 1, the RLC SDU 3 and the RLC SDU 4.

In one embodiment, the fourth data unit set comprises a data unit not successfully received by the second node in the second data unit set.

In one embodiment, the fifth data unit set comprises a data unit not transmitted in the first data unit set.

In one embodiment, a data unit in the fifth data unit set comprises a data unit in which at least partial bits are not transmitted in the first data unit set.

In one embodiment, the sixth data unit set comprises a data unit not successfully received by the first node.

In one embodiment, the sixth data unit set comprises a data unit in which at least partial bits are not successfully received by the first node.

In one embodiment, the third data unit set comprises a data unit not successfully transmitted in the first data unit set.

In one embodiment, the third data unit set comprises a data unit comprising the fourth data unit set in the first data unit set and a data unit comprised in the fifth data unit set.

In one embodiment, the third data unit set comprises a data unit comprising the fourth data unit set in the first data unit set, a data unit comprised in the fifth data unit set and a data unit comprised in the sixth data unit set.

In one embodiment, the first node strips an RLC data PDU header of a received RLC data PDU in the second RLC entity to obtain an RLC SDU; the RLC SDU belongs to the first data unit set; and the RLC data PDU header comprises an SN of the RLC SDU.

In one embodiment, the first node maintains an SN of each data unit comprised in the first data unit set in the second logical channel transmission.

In one embodiment, the first node maintains a mapping relation between an SN of each data unit comprised in the second data unit set and an SN of a data unit in the first data unit set to which each data unit in the second data unit set belongs.

In one subembodiment of the above embodiment, the first node obtains a data unit in the first data unit set to which each data unit in the fourth data unit set belongs according to the mapping relation.

### Embodiment 7

Embodiment 7 illustrates a format schematic diagram of a second control message and a third control message according to one embodiment of the present disclosure, as shown in FIG. 7.

In one embodiment, the second control message and the third control message respectively comprise an RLC control PDU; and the RLC control PDU comprises a STATUS PDU.

In FIG. 7, a D/C field comprised in the STATUS PDU is 0; a Control PDU Type (CPT) field is 000 indication STATUS PDU; an Acknowledgement (ACK) sequence number (ACK_SN) field indicates an SN of a next RLC SDU to be received; an Extension 1 (E1) field indicates whether there are more NACK_SNs, E1s, E2s and E3s; R field is reserved; a Negative Acknowledgement (NACK) sequence number (NACK_SN) field indicates an SN of an RLC SDU or an RLC SDU segment that is not successfully received; an E2 field indicates whether there are SOstart and SOend after the NACK_SN field, and the NACK_SN field is associated with the SOstart and the SOend respectively; an E3 field indicates whether there is a NACK range field after the NACK_SN field, and the NACK_SN field is associated with the NACK range; the SOstart and the SOend respectively indicate a start octet and an end octet of an RLC SDU segment indicated by the NACK_SN in an original RLC SDU; the NACK range field indicates a number of consecutive not successfully received RLC SDUs starting from a NACK_SN; herein, as shown in FIG. 7, the ACK_SN field and the NACK_SN field respectively comprise 12 bits; for formats of the ACK_SN field and the NACK_SN field respectively comprising 18 bits, refer to 3GPP specification 38.322.

In one embodiment, at least the former of the NACK_SN field, the SOstart field, the SOend field, and the NACK range field in the STATUS PDU is used to indicate a data unit set not successfully received; the fourth data unit set and the sixth data unit set respectively comprise a data unit set not successfully received.

### Embodiment 8

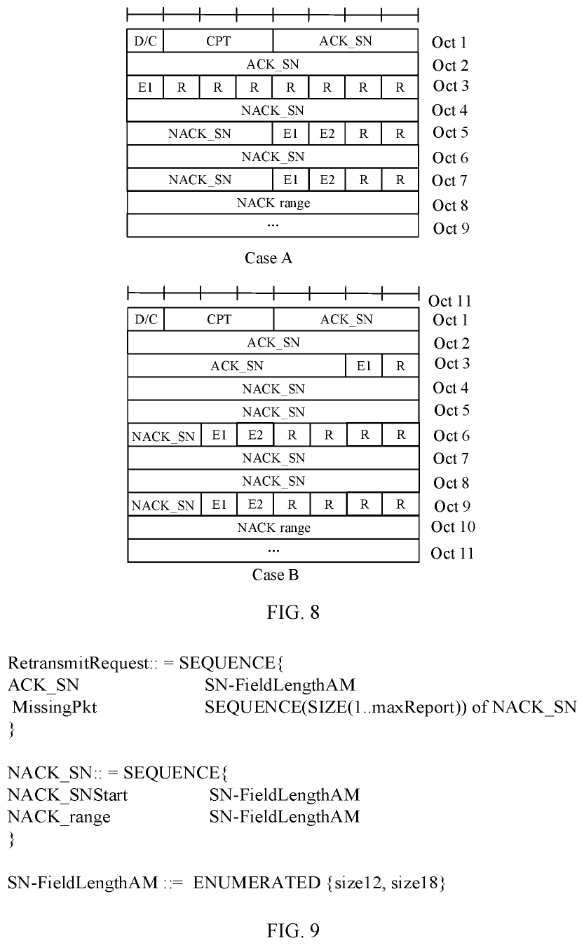

Embodiment 8 illustrates a schematic diagram of a format of a first control message according to one embodiment of the present disclosure, as shown in FIG. 8.

In one embodiment, the first control message comprises an RLC control PDU; and the RLC control PDU comprises a RELAY STATUS PDU.

In one embodiment, a CPT field comprised in the RELAY STATUS PDU in the first control message is 001.

In one embodiment, a CPT field comprised in the RELAY STATUS PDU in the first control message is one of 010, or 011, or 100, or 101, or 110, or 111.

In FIG. 8, a D/C field comprised in the RELAY STATUS PDU is 0; a Control PDU Type (CPT) field indicates a RELAY STATUS PDU; a ACK_SN field indicates an SN of a next RLC SDU to be received; an Extension 1 (E1) field indicates whether there are more NACK_SNs, E1s and E2s; an R field is reserved; a NACK_SN field indicates an SN of an RLC SDU not successfully transmitted; an E2 field indicates whether there is a NACK range field after the NACK_SN field, and the NACK range field indicates a number of consecutive RLC SDUs not successfully transmitted starting from a NACK_SN.

In case A of FIG. 8, the ACK_SN field and the NACK_SN field respectively comprise 12 bits.

In case B of FIG. 8, the ACK_SN field and the NACK_SN field respectively comprise 18 bits.

In one embodiment, the RELAY STATUE PDU at least comprises a NACK_SN field.

In one embodiment, at least the former of the NACK_SN field and the NACK range field in the RELAY STATUS PDU is used to indicate a data unit set not successfully transmitted; and the third data unit set comprises a data unit set not successfully transmitted.

In one embodiment, the ACK_SN and the NACK_SN comprised in the RELAY STATUS PDU indicate an SN of the third data unit set in the second logical channel transmission.

In one embodiment, the second node obtains the third data unit set and indicates it to a higher layer.

In one embodiment, the higher layer is a PDCP sublayer.

In one embodiment, the second node obtains a PDCP SN of each data unit comprised in the third data unit set at an RLC sublayer and indicates it to an PDCP sublayer.

### Embodiment 9

Embodiment 9 illustrates a schematic diagram of another format of a first control message according to one embodiment of the present disclosure, as shown in FIG. 9.

In one embodiment, the first control message comprises an IE of an RRC message.

In FIG. 9, an ACK_SN field indicates an SN of a next SDU to be received; MissingPkt indicates an SN of an SDU not successfully transmitted; herein, a NACK_SNStart field indicates an SN of an SDU not successfully transmitted, and a NACK range field indicates a number of consecutive SDUs not successfully transmitted starting from a NACK_SN; maxReport indicates a maximum number of SDU sets that are not successfully transmitted and can be transmitted at the same time, where an SDU set comprises at least one SDU; SN-FiledLengthAM takes 12 bits, or 18 bits, and the SN-FiledLengthAM field indicates a size of an SN; when the SN-FiledLengthAM field comprises 12 bits, the maxReport is a positive integer not greater than 2¹²; when the SN-FiledLengthAM field comprises 18 bits, the maxReport is a positive integer not greater than 2¹⁸.

In one embodiment, the SDU is an RLC SDU.

In one embodiment, the SDU is a PDCP SDU.

In one embodiment, the ACK_SN and the NACK_SN comprised in the RRC message indicate an SN of each data unit in the third data unit set during a PDCP sublayer transmission.

In one embodiment, the second node obtains a PDCP SN of each data unit comprised in the third data unit set at an RRC sublayer and indicates it to an PDCP sublayer.

### Embodiment 10

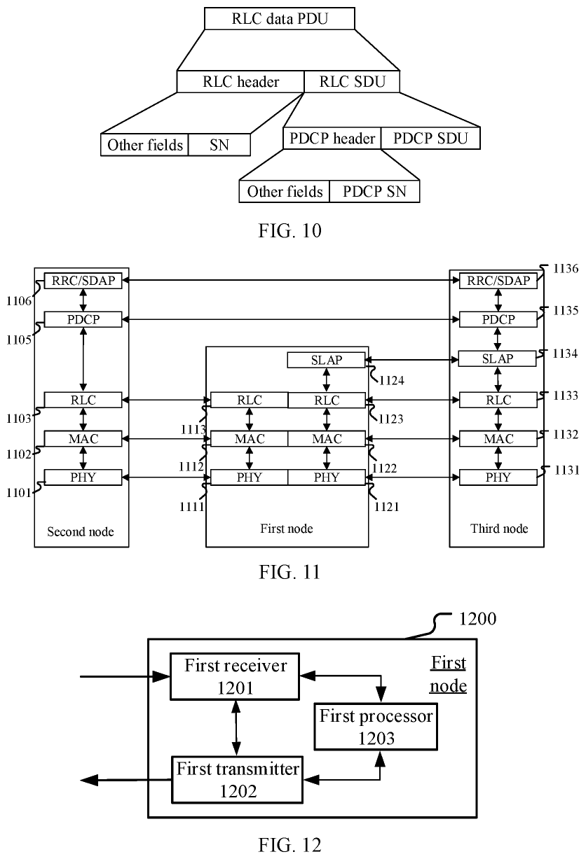

Embodiment 10 illustrates a schematic diagram of a format of an RLC data PDU according to one embodiment of the present disclosure, as shown in FIG. 10.

In FIG. 10, an RLC data PDU comprises an RLC header and an RLC SDU; an RLC header comprises an SN field and other fields; other SN fields indicate an SN of an RLC SDU; an RLC SDU comprises a PDCP header and a PDCP SDU; a PDCP header comprises a PDCP SN field and other fields; and other PDCP SN fields indicate an SN of a PDCP SDU.

### Embodiment 11

Embodiment 11 illustrates a schematic diagram of a radio protocol architecture of relay transmissions according to one embodiment of the present disclosure, as shown in FIG. 11.

In FIG. 11, in a relay transmission, take data transmitted by a second node through a first node to a third node as an example (data is transmitted by the third node through the first node to the second node in the same way): first target data generates a first target MAC PDU at MAC sublayer 1102 after successively being processed by PDCP sublayer 1105 and RLC sublayer 1103 at the second node side, then is transmitted to PHY layer 1101, and then is transmitted to PHY layer 1111 of a first node via an air interface, and recovers first RLC data through the processing of MAC sublayer 1112 and RLC sublayer 1113; the first RLC data is processed by SLAP sublayer 1124 to regenerate second RLC data in the RLC sublayer 1123, and then is processed by MAC sublayer 1122 to generate a second target MAC PDU to be transmitted to PHY layer 1121; then is transmitted to PHY layer 1131 of a third node via an air interface, and recovers a second target MAC PDU through MAC sublayer 1132, then recovers a first target data successively through the processing of RLC sublayer 1133, SLAP sublayer 1134 and PDCP sublayer 1135.

In one embodiment, an RLC entity 1113 maintained by the first node corresponds to an RLC entity 1103 maintained by the second node.

In one embodiment, a transmission through the second logical channel comprises a transmission between an RLC entity 1113 of the first node and an RLC entity 1103 of the second node.

In one embodiment, an RLC entity 1123 maintained by the first node corresponds to an RLC entity 1133 maintained by the third node.

In one embodiment, a transmission through the first logical channel comprises a transmission between an RLC entity 1123 of the first node and an RLC entity 1133 of the second node.

In one embodiment, the first node maintains a first RLC entity and a second RLC entity; and the first RLC entity corresponds to a first RLC channel; the second RLC entity corresponds to a second RLC channel.

In one embodiment, the second RLC entity regroups RLC SDU segments comprised in received multiple RLC data PDCUs to generate an RLC SDU.

In one embodiment, the first RLC entity segments an RLC SDU to generate multiple RLC SDU segments.

In one embodiment, the SLAP sublayer implements bearer mapping function.

In one embodiment, the bearer mapping function maps a second RLC bearer mapping to a first RLC bearer; the second RLC bearer comprises the second logical channel; and the first RLC bearer comprises the first logical channel.

In one embodiment, the second RLC channel is mapped to the first RLC channel.

In one embodiment, a data unit received from the second logical channel is forwarded through the first logical channel.

In one embodiment, the SLAP sublayer implements routing function.

In FIG. 9, the routing function forwards a data unit received from the second node to the third node.

In one embodiment, each data unit in the first data unit set generates an SLAP PDU in the SLAP sublayer; the SLAP PDU comprises an SLAP header and an SLAP SDU indicated by the SLAP header; and the SLAP SDU is an RLC SDU.

In one embodiment, the SLAP header comprises a source transmitter ID of an SLAP SDU indicated by the SLAP header.

In one embodiment, the SLAP header comprises a target receiver ID of an SLAP SDU indicated by the SLAP header.

In one embodiment, the SLAP header comprises a radio bearer ID to which an SLAP SDU indicated by the SLAP header belongs.

In one embodiment, the SLAP header comprises an SN of an SLAP SDU indicated by the SLAP header.

In FIG. 9, the source transmitter is the second node; and the target receiver is the third node.

### Embodiment 12

Embodiment 12 illustrates a structure block diagram of a processing device in a first node according to one embodiment of the present disclosure, as shown in FIG. 12. In FIG. 12, a processing device 1200 in a first node comprises a first receiver 1201, a first transmitter 1202 and a first processor 1203. The first receiver 1201 comprises at least one of the transmitter/receiver 454 (including the antenna 452), the receiving processor 456, the multi-antenna receiving processor 458 or the controller/processor 459 in FIG. 4 of the present disclosure; the first transmitter 1202 comprises at least one of the transmitter/receiver 454 (including the antenna 452), the transmitting processor 468, the multi-antenna transmitting processor 457, or the controller/processor 459 in FIG. 4 of the present disclosure; and the first processor 1203 comprises the data source 467 in FIG. 4 of the present disclosure.

In embodiment 12, a first receiver 1201 receives a first data unit set through a second logical channel, the first data unit set comprises at least one data unit; a first transmitter 1202 transmits a second data unit set through a first logical channel, and the second data unit set comprises at least one data unit; a first processor 1203 determines a first link failure; as a response to the behavior of determining the first link failure, generates a first control message; and the first transmitter 1202 transmits the first control message; herein, the first control message is used to indicate that a third data unit set is not successfully transmitted; any data unit in the third data unit set belongs to the first data unit set; any bit in the second data unit set belongs to the first data unit set; and a data unit comprised in the first logical channel is transmitted via the first link at air interface.

In one embodiment, the first receiver 1201 also receives a second control message; herein, the second control message indicates that a fourth data unit set is not successfully received; the fourth data unit set belongs to the second data unit set; any data unit in the fourth data unit set comprises at least partial bits of a data unit in the third data unit set.

In one embodiment, the first transmitter 1202 transmits a third control message; herein, the third control message indicates that the first data unit set is successfully received.

In one embodiment, the third data unit set comprises a fifth data unit set. herein, any bit in the fifth data unit set belongs to the first data unit set and at least partial bits do not belong to the second data unit set; any data unit in the fifth data unit set is mapped to the first logical channel.

In one embodiment, the first control message is transmitted through a second logical channel; herein, the second logical channel is mapped to the first logical channel.

In one embodiment, the first control message indicates that the sixth data unit set is not successfully received; herein, the sixth data unit set is received through the second logical channel and does not belong to the first data unit set.

In one embodiment, the first control message indicates the first link failure.

### Embodiment 13

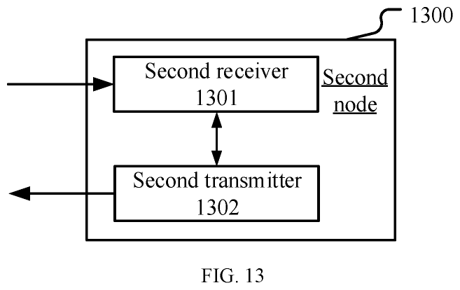

Embodiment 13 illustrates a structure block diagram of a processing device in a second node according to one embodiment of the present disclosure, as shown in FIG. 13. In FIG. 13, a processing device 1300 in a second node comprises a second receiver 1301 and a second transmitter 1302. The second receiver 1301 comprises at least one of the transmitter/receiver 418 (including the antenna 420), the receiving processor 470, the multi-antenna receiving processor 472 or the controller/processor 475 in FIG. 4 of the present disclosure; the second transmitter 1302 comprises at least one of the transmitter/receiver 418 (including the antenna 420), the transmitting processor 416, the multi-antenna transmitting processor 471 or the controller/processor 475 in FIG. 4 of the present disclosure.

In embodiment 13, the second transmitter 1302 transmits a first data unit set through a second logical channel, the first data unit set comprises at least one data unit; the second receiver 1301 receives a first control message; herein, a second data unit set is transmitted through a first logical channel, and the second data unit set comprises at least one data unit; a first link is determined as failed; as a response to the behavior of the first link being determined as failed, the first control message is generated; the first control message is used to indicate that a third data unit set is not successfully transmitted; any data unit in the third data unit set belongs to the first data unit set; any bit in the second data unit set belongs to the first data unit set; and a data unit comprised in the first logical channel is transmitted via the first link at air interface.

In one embodiment, a second control message is received; herein, the second control message indicates that a fourth data unit set is not successfully received; the fourth data unit set belongs to the second data unit set; any data unit in the fourth data unit set comprises at least partial bits of a data unit in the third data unit set.

In one embodiment, the second receiver 1301 receives a third control message; herein, the third control message indicates that the first data unit set is successfully received.

In one embodiment, the third data unit set comprises a fifth data unit set. herein, any bit in the fifth data unit set belongs to the first data unit set and at least partial bits do not belong to the second data unit set; any data unit in the fifth data unit set is mapped to the first logical channel.

In one embodiment, the first control message is transmitted through a second logical channel; herein, the second logical channel is mapped to the first logical channel.

In one embodiment, the first control message indicates that the sixth data unit set is not successfully received; herein, the sixth data unit set is received through the second logical channel and does not belong to the first data unit set.

In one embodiment, the first control message indicates the first link failure.

The ordinary skill in the art may understand that all or part of steps in the above method may be implemented by instructing related hardware through a program. The program may be stored in a computer readable storage medium, for example Read-Only Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. A first-type communication node or a UE or a terminal in the present disclosure includes but not limited to mobile phones, tablet computers, laptops, network cards, low-power devices, enhanced Machine Type Communication (eMTC) devices, NB-IOT devices, vehicle-mounted communication equipment, aircrafts, airplanes, unmanned aerial vehicles (UAV), tele-controlled aircrafts and other wireless communication devices. The second-type communication node or the base station or the network side device in the present disclosure includes but is not limited to the macro-cellular base stations, micro-cellular base stations, home base stations, relay base stations, eNB, gNB, Transmission and Reception Points (TRP), relay satellites, satellite base stations, air base stations and other wireless communication equipment.

The above are merely the preferred embodiments of the present disclosure and are not intended to limit the scope of protection of the present disclosure. Any modification, equivalent substitute and improvement made within the spirit and principle of the present disclosure are intended to be included within the scope of protection of the present disclosure.

What is claimed is:

1. A first node for wireless communications, comprising:
a first receiver, receiving a first data unit set through a second logical channel, the first data unit set comprising at least one data unit;
a first transmitter, transmitting a second data unit set through a first logical channel, the second data unit set comprising at least one data unit;
a first processor, determining a first link failure; as a response to the behavior of determining the first link failure, generating a first control message; and
the first transmitter, transmitting the first control message;
wherein the first control message is used to indicate that a third data unit set is not successfully transmitted; any data unit in the third data unit set belongs to the first data unit set; any bit in the second data unit set belongs to the first data unit set; and a data unit comprised in the first logical channel is transmitted via the first link at air interface.

2. The first node according to claim 1, comprising:
the first receiver, receiving a second control message;
wherein the second control message indicates that a fourth data unit set is not successfully received; the fourth data unit set belongs to the second data unit set; any data unit in the fourth data unit set comprises at least partial bits of a data unit in the third data unit set.

3. The first node according to claim 1, comprising:
the first transmitter, transmitting a third control message;
wherein the third control message indicates that the first data unit set is successfully received.

4. The first node according to claim 1, wherein the third data unit set comprises a fifth data unit set;
wherein any bit in the fifth data unit set belongs to the first data unit set and at least partial bits do not belong to the second data unit set; any data unit in the fifth data unit set is mapped to the first logical channel.

5. The first node according to claim 1, wherein the first control message is transmitted through the second logical channel;
wherein the second logical channel is mapped to the first logical channel.

6. The first node according to claim 1, wherein the first control message indicates that a sixth data unit set is not successfully received;
wherein the sixth data unit set is received through the second logical channel and does not belong to the first data unit set.

7. The first node according to claim 1, wherein the first control message indicates the first link failure.

8. A second node for wireless communications, comprising:
a second transmitter, transmitting a first data unit set through a second logical channel, the first data unit set comprising at least one data unit; and
a second receiver, receiving a first control message;
wherein a second data unit set is transmitted through a first logical channel, and the second data unit set comprises at least one data unit; a first link is determined as failed; as a response to the behavior of the first link being determined as failed, the first control message is generated; the first control message is used to indicate that a third data unit set is not successfully transmitted; any data unit in the third data unit set belongs to the first data unit set; any bit in the second data unit set belongs to the first data unit set; and a data unit comprised in the first logical channel is transmitted via the first link at air interface.

9. The second node according to claim 8, wherein a second control message is received;
wherein the second control message indicates that a fourth data unit set is not successfully received; the fourth data unit set belongs to the second data unit set; any data unit in the fourth data unit set comprises at least partial bits of a data unit in the third data unit set.

10. The second node according to claim 8, comprising:
the second receiver, receiving a third control message;
wherein the third control message indicates that the first data unit set is successfully received.

11. The second node according to claim 8, wherein the third data unit set comprises a fifth data unit set;
wherein any bit in the fifth data unit set belongs to the first data unit set and at least partial bits do not belong to the second data unit set; and any data unit in the fifth data unit set is mapped to the first logical channel.

12. The second node according to claim 8, wherein the first control message is transmitted through the second logical channel;
wherein the second logical channel is mapped to the first logical channel.

13. The second node according to claim 8, wherein the first control message indicates that a sixth data unit set is not successfully received;
wherein the sixth data unit set is received through the second logical channel and does not belong to the first data unit set.

14. The second node according to claim 8, wherein the first control message indicates the first link failure.

15. A method in a first node for wireless communications, comprising:
receiving a first data unit set through a second logical channel, the first data unit set comprising at least one data unit;
transmitting a second data unit set through a first logical channel, the second data unit set comprising at least one data unit;
determining a first link failure; as a response to the behavior of determining the first link failure, generating a first control message; and
transmitting a first radio signal, the first radio signal carrying the first control message;
wherein the first control message is used to indicate that a third data unit set is not successfully transmitted; any data unit in the third data unit set belongs to the first data unit set; any bit in the second data unit set belongs to the first data unit set; and a data unit comprised in the first logical channel is transmitted via the first link at air interface.

16. The method in a first node according to claim 15 comprising:
receiving a second control message;
wherein the second control message indicates that a fourth data unit set is not successfully received; the fourth data unit set belongs to the second data unit set; any data unit in the fourth data unit set comprises at least partial bits of a data unit in the third data unit set.

17. The method in a first node according to claim 15, comprising:
transmitting a third control message;
wherein the third control message indicates that the first data unit set is successfully received.

18. The method in a first node according to claim 15, wherein the third data unit set comprises a fifth data unit set;
wherein any bit in the fifth data unit set belongs to the first data unit set and at least partial bits do not belong to the second data unit set; any data unit in the fifth data unit set is mapped to the first logical channel.

19. The method in a first node according to claim 15, wherein the first control message is transmitted through the second logical channel;
wherein the second logical channel is mapped to the first logical channel.

20. The method in a first node according to claim 15, wherein the first control message indicates that a sixth data unit set is not successfully received;
wherein the sixth data unit set is received through the second logical channel and does not belong to the first data unit set.
